(19) United States
(12) Patent Application Publication
(10) Pub. No.: US 2024/0257611 A1
(43) Pub. Date: Aug. 1, 2024

(54) TOOL POOL ELECTRONIC GAMING MACHINE PLAY

(71) Applicant: IGT, Las Vegas, NV (US)

(72) Inventors: Robert Silva, Reno, NV (US); Dwayne Nelson, Las Vegas, NV (US)

(21) Appl. No.: 18/101,649

(22) Filed: Jan. 26, 2023

(51) Int. Cl. G07F 17/32

(52) U.S. Cl. CPC G07F 17/3255; G07F 17/3239; G07F 17/3258

(57) ABSTRACT

Embodiments of the present disclosure are directed to managing and conducting player pools. In one embodiment, players can join a player pool and play to win a particular prize. When the prize is hit, the pool is divided amongst the players based on their wager contributions. In another embodiment, the player pool can accumulate win amounts from all or some wins from players. As members of the player pool win, the win amount can be added to the player pool. At some point in time the player pool can distribute the wins across the members based on the wager contributions and/or win amounts.

### BACKGROUND

Embodiments of the present disclosure relate generally to managing game play on electronic gaming systems and more particularly to managing player pools for users of electronic gaming systems.

People often visit casinos or other gaming venues as part of a social event or activity. For example, a married couple or members of a family may visit Las Vegas or other location to play gambling games at a casino or other venue. In other cases, members of a tour group, participants in a conventions, or other similar groups may also visit such locations and gamble any of a variety of games. To increase an incentive to play such games and thereby increase potential revenues to the casino or gaming venue, there is a need for methods and systems that encourage thee social aspects of gaming.

### BRIEF SUMMARY

According to one embodiment, a method for managing player pools can comprise maintaining a plurality of electronic records, each record of the plurality of electronic records defining a player pool of a plurality of player pools. A player of the gaming venue can be identified and an ordered list of the plurality of player pools can be generated based on the plurality of electronic records. The ordered list can be ordered based on any one or more of a number of players in each player pool of the plurality of player pools, a total amount of credit contributed by players in each player pool of the plurality of player pools, a total amount of winnings accumulated in each player pool of the plurality of player pools, and/or other factors.

The generated ordered list of the plurality of player pools can be present to the player. In some cases, presenting the generated ordered list of the plurality of player pools to the player can further comprise providing an indication of an available incentive for joining one of the player pools of the plurality of player pools. For example, the incentive can comprise an award of loyalty points. Additionally, or alternatively, presenting the generated ordered list of the plurality of player pools to the player can comprise presenting at least a portion of the generated ordered list trough a social media account. Presenting the generated ordered list of the plurality of player pools to the player can additionally, or alternatively, comprise indicating a recommended player pool of the plurality of player pools.

According to another embodiment, a system can comprise a processor and a memory coupled with and readable by the processor. The memory can store therein a set of instructions which, when executed by the processor, causes the processor to maintain a plurality of electronic records, each record of the plurality of electronic records defining a player pool of a plurality of player pools. The instructions can further cause the processor to identify a player of the gaming venue, generate a list of the plurality of player pools based on the plurality of electronic records and present the generated list of the plurality of player pools to the player.

The instructions can further cause the processor to receive, from the player, a selection of two of the plurality of player pools and generate a new electronic record of the plurality of records, the new electronic record defining a new player pool of the plurality of player pools based on the electronic records defining the selected two of the plurality of player pools. The new record can define any one or more of a pool leader for the new player pool, a geographic location for the new player pool, a maximum number of players for the new player pool, a theme for the new player pool, a rule for allocating winnings for the new player pool, and/or other information for the player pool.

According to yet another embodiment, a method for conducting a player pool can comprise maintaining, by a pool management system, a plurality of electronic records, each record of the plurality of electronic records defining a configuration for a player pool of a plurality of player pools. A player of the gaming venue can be identified and an ordered list of the plurality of player pools based on the plurality of electronic records. The generated ordered list of the plurality of player pools can be provided to the player.

An indication of a selected player pool of the plurality of player pools can be received from the player and the selected player pool can be conducted according to the configuration defined for the selected player pool. For example, the configuration defined for the selected player pool can define a rule for the player leaving the selected player pool. Such a rule for the player leaving the selected player pool may allow the player to return to the selected player pool for a predefined period of time. Additionally, or alternatively, the configuration defined for the selected player pool can define a rule for handling an award of winnings in the selected player pool. For example, the rule for handling the award of winnings in the selected player pool can award the winnings to a predefined number of top players in the selected player pool. In another example, the rule for handling the award of winnings in the selected player pool can award the winnings based on a result of playoff round for the selected player pool.

Additional features and advantages are described herein and will be apparent from the following Description and the figures.

### BRIEF DESCRIPTION OF THE SEVERAL VIEWS OF THE DRAWINGS

FIG. 1 is a block diagram illustrating an exemplary environment for managing player pools according to one embodiment of the present disclosure.

FIG. 2 illustrates a set of exemplary user interfaces for presenting player pools according to one embodiment of the present disclosure.

FIG. 3 is a block diagram illustrating an exemplary pool definition data structure according to one embodiment of the present disclosure.

FIG. 4 is a block diagram illustrating additional details of an exemplary pool management system according to one embodiment of the present disclosure.

FIG. 5 is a flowchart illustrating an exemplary process for managing and conducting player pools according to one embodiment of the present disclosure.

FIG. 6 is a flowchart illustrating an exemplary process for configuring player pools according to one embodiment of the present disclosure.

### DETAILED DESCRIPTION

Embodiments of the present disclosure will be described in connection with managing and conducting player pools in which participants share in a result of gaming activities. For example, a group of players can pool their money and use that pool amount as game play credits at Electronic Gaming Machines (EGMs), Electronic Table Games (ETGs), or other games within a casino or other gaming venue. In another example, participants can pool game play results, i.e., winnings, and split or share some or all of the winnings. Each player pool can be configured in a variety of different ways. These configurations can include defining or identifying a leader for the player pool, a geographic location for the player pool, a minimum and/or maximum number of players for the player pool, a theme for the player pool, and/or other factors. In some cases, one or more rules can define how the player pool amount is used, how game winnings are returned to the pool or otherwise handled, how a remaining amount of the prize pool, if any, is handled after game play of all participant had finished, etc.

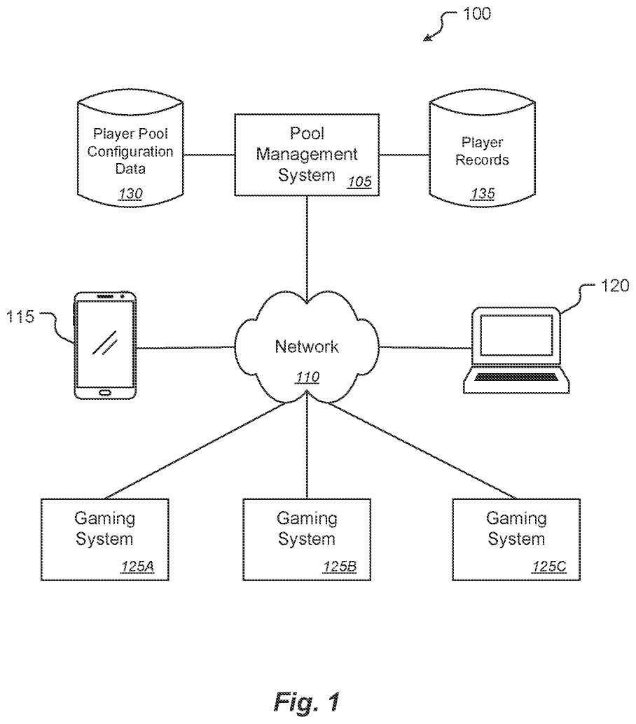

FIG. 1 is a block diagram illustrating an exemplary environment for managing player pools according to one embodiment of the present disclosure. As illustrated in this example, the environment 100 can comprise a pool management system 105 which can comprise one or more servers and/or other computing devices or systems within a casino or other gaming venue. The pool management system 105 can be communicatively coupled with one or more wired and/or wireless communications networks 110. According to one embodiment, a mobile device 115 such as a cellular phone, tablet, or other portable computing device of a player visiting the casino or other gaming venue can also be communicatively coupled with the pool management system 105 through the communications network 110. As will be described, the player can, through the mobile device 115, request to initiate and/or configure a player pool, view existing player pools, join a player pool, make a contribution to a player pool etc. Additionally, or alternatively, a kiosk system 120 or other computing device or system can also be communicatively coupled with the pool management system 105 through the communications network 110 and can be used by players visiting the casino or other gaming venue to request to initiate and/or configure a player pool, view existing player pools, join a player pool, make a contribution to a player pool etc. In some embodiments a player can join multiple player pools to have multiple chances at winning. This ability and/or the number of simultaneous pools possible can be configured by the pool management system 105.

A number of gaming systems 125A-125C can also be communicatively coupled with the communications network 110. These gaming systems 125A-125C can include, but are not limited to, and any of a variety of known Electronic Gaming Machines (EGMs), Electronic Table Games (ETGs), and/or similar gaming systems found in casinos and other gaming venues. Generally speaking, through the mobile device 115 or kiosk system 120, a player can establish and configure one or more player pools in which a number of players are contributing to the pool, cooperatively playing at one or more gaming systems 125A-125C, and/or sharing the winnings or yield of playing sessions. For example, players can register in a player pool managed by the pool management system 105 and add funds to the player pool through the kiosk system 120 or a mobile account associated with the mobile device 115 of the player to dedicate a certain amount of money to be played at the location. In another example, players can participate in a player pool which accumulates winnings from games played by various players of difference gaming systems 125A-125C and splits or shares those winnings between some or all of the players in the player pool depending on how the player pool is configured. In either case, the player pool can be defined by and managed according to a set of player pool configuration data 130 maintained by the pool management system 105. In one embodiment the player pool can remain after the win and the pool management system 105 can reset the prize amount for the next win. The pool management system 105 can also reset contributions to the player pool to zero and continue the player pool. This can be the case for a long running pool, e.g., of friends or family members, who do not need to continually join the same pool over and over.

Depending upon the configuration data 130, a player pool may have a specific theme or other configuration such as to 5 cent denomination. In some cases, player activity may only count while playing this predefined contribution. For example, if the pool was specifically created for $1.00 play, a player playing at 25 cents would not be contributing to the pool. In one embodiment the pool management system 105 automatically enters each player to play at the pool configuration, i.e., forces the player to play the $1.00. In another embodiment, when the player “cards into” an EGM or other gaming system 125A using a player card, the pool management system 105 can download the defined theme for the player pool to the EGM or other gaming system 125A and therefore enforces that the player plays the pool game. In one embodiment a player pool can be a single theme, while another player pool can span multiple themes or win categories. For example, a player pool might be to play “Megabucks to win the top prize” or it might be to play “Any poker game and win a progressive royal flush”.

In one embodiment a kiosk 120 service window, EGM or gaming system 125A, or application on a mobile device 115 can prompt the player to join a player pool. This might be triggered by a cash in, or when the player plays a theme where a player pool is allowed. In one embodiment the pool management system 105 can consider friends of the player who are already in a player pool, or player pools in which there are people which the player previous pooled with. The pool management system 105 might determine friends from the phone contacts, player account, or social media of the player. This information may be stored by the pool management system 105 or another system (not shown here) in a set of player records 135.

In one embodiment the pool management system 105 can suggest a pool to join and offer that to the player, e.g., through the mobile device 115, kiosk system 120, or gaming system 125A. For example, the pool management system 105 can be configured to offer the most recently created pool to the user. In some cases, the player may be presented one or more leader boards or displays showing a list of pools. The list might be ranked, for example, by the number of players, amount wagered, total win amount accumulated, time played, time since creation, or other factors. In one embodiment, a player might view the members of a pool, their contributions and the setting of the pool.

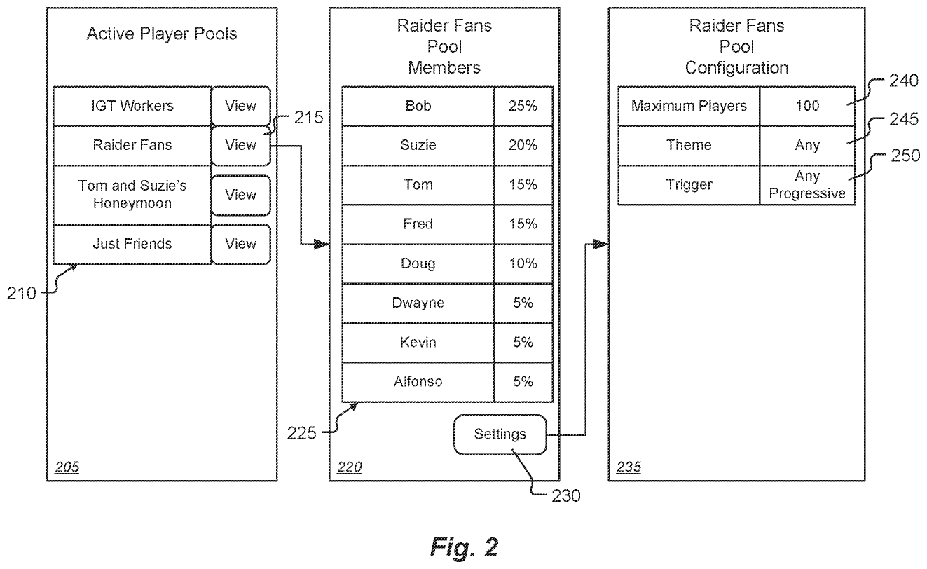

FIG. 2 illustrates a set of exemplary user interfaces for presenting player pools according to one embodiment of the present disclosure. As illustrated in this example, a first user interface 205 may be presented that includes a list 210 of available player pools. As noted, the list 210 may be ordered based on any of a variety of factors. Additionally, or alternatively, player pools presented in the list 210 may be selected from a larger set of available player pools based on preferences and/or other information from player records 135 as also described above. The first user interface 205 may also include a button 215, link, or other control to allow the player to view additional details about a particular player pool.

In response to the player clicking the button 215 or otherwise indicating or selecting one of the player pools in the list 210, a second user interface 220 may be presented. As illustrated in this example, this second user interface 220 can present a list 225 of pool members for the selected player pool. The second user interface 220 can also include a button 230, link, or other control for viewing additional information about the player pool including, but not limited to, settings or a configuration for the player pool.

In response to the player clicking the button 230 or otherwise requesting the additional information, a third user interface 235 may be presented. This third user interface 235 can present configuration information about the player pool including, but not limited to a maximum number of players 240 permitted in the player pool, a theme 245 for the player pool, a trigger 250 for a payout or award for the player pool, and/or others.

According to one embodiment, the pool management system 105 can promote player pools in various ways. For example, the pool management system 105 might rank or order player pool based on various factors as described above and show which player pools have the most players or wagers. In another example, the player pools can be linked by the pool management system 105 with one or more social media accounts. The pool management system 105 can, through these accounts, publish activity within the player pool such as number of players, amount of wagers, games played, time played, etc. The social media linkage might compare the statistics to other player pools such as “Our pool is ranked 3rd for total wagers.” In one embodiment, players and/or the player pool creator can opt out or into social media and other broadcasting of their player pool information.

According to one embodiment, awarding of a player pool prize or winning amount by the pool management system 105 can be triggered when one or more special prizes, such as a progressive, are hit by a player pool member. In another embodiment, wins can be added to the player pool by the pool management system 105 and those wins can be distributed amongst players by the pool management system 105. It is possible that the player pool amount can be awarded by the pool management system 105 from another trigger, such as after a time limit. For example, the awarding could be triggered by a player pool member hitting of one or more special awards, a time limit, such as after 1 hour of play or at the end of the day, a vote of the player pool members, a player leaving the player pool, and/or other events. In one embodiment when the player leaves the player pool, the player's percentage of contribution can be given to the player immediately upon leaving the player pool.

In some cases, the player might have the option to win a player pool while not present in a particular location, e.g., a casino or other gaming venue. In such cases, the player can have a wagering account maintained by the pool management system 105 or other system and used to join the player pool. If somebody in the pool wins the jackpot, the amount could be transferred to the wagering account. In some cases, people in the pool might win additional player loyalty points for all or certain activities while in the player pool. Additionally, or alternatively, when a trigger happens and a player pool wins, losing player pools might receive some consolation prize such as player points, buffet tickets, free play, e.g., promotional credits, etc.

According to one embodiment, the win can be evenly divided by the pool management system 105 based on the percentage of play between the players. In another embodiment the percentage can be affected by one or more of being the pool creator or leader, amount of time in the pool, game triggers hit while being in the pool such as bonuses or free spins, rank within the pool, e.g., players with more wagers contributed might get a slightly bigger percentage, a random parameter such as a random game played in the service window or mobile device that determines the final percentage for each player, and/or other factors. In some cases, players could opt into a second game to change or eliminate the percentage, e.g., a sudden death round that cuts the size of the player pool in half or down to a few people.

A player pool's previous history can also be considered by the pool management system 105. For example, players who were in the player pool group long before a progressive reset can be given a higher percentage. In some cases, a vote could be triggered by the pool management system 105 to decide if the members want to participate in the additional games on the win. For example, if the prize is $25,000 and there are 1,000 members, each member will be awarded $25 for being a member. The members might vote to play a game to limit the pool to 10 people and get a much larger award win.

According to one embodiment, the win could be split by the pool management system 105 based on total win contributed or split by total wager contribution or some combination thereof. For a player pool where the wager is the contribution factor the win amount for a player can be:

$$( [ Player ’ s Total Wager Amount ] \text{} / [ \text{} All Players Wager Amount ] ) \times [ \text{} Prize Amount ]$$

$$For a player pool where the wins are added to the pool the win amount for a player can be :$$

$$( [ Player ’ s Total Win Contributed ] \text{} / [ \text{} All Player Win Contributions ] ) \times [ Total Win Contributions ]$$

In one embodiment, the number of players to win money from the player pool can be smaller than the number of members in the player pool. For example, there might be 87 players in the pool but only the top 10 players split the awards from the pool (either 10% each or pro-rated by their contributions/wins). In this embodiment a leaderboard maintained by the pool management system 105 can shows which players are in the top ten. In a related embodiment the top players can scale their win completely or partially based on the rank in the player pool. For example, the person ranked number 1 receives more than the person ranked number 10.

In one embodiment, cashing out can cause the player to leave a player pool. The pool management system 105, through a gaming system 125A, service window of a kiosk system 120, or application of a mobile device 115, can notify the player that they are leaving the pool. In some cases, the player may be allowed to cancel to the cash out to remain in the pool. In other cases, the player may be given a certain amount of time to insert money to maintain membership in the player pool. In other embodiments, the pool management system 105 can keep the player's previous activity in the pool when the player cashes out, but not consider future activity by the player to be part of the player pool. In one embodiment, when a player leaves the player pool, the pool management system 105 can award the player their share of the wins gathered, i.e., for a player pool which is accumulating the wins for all players.

According to one embodiment, a player might sell or trade their pool membership to other players. In such cases, the pool management system 105 can show the player, through a service window of a kiosk system 120 or application of a mobile device 115, the expected values of the membership. For example, if the prize is $25,000 and the player has wagered 10% of the pool, the pool management system 105 might show the player the 10% contribution percentage and $2,500 (10% of the prize).

According to one embodiment, a player pool leader, using a configuration user interface presented by the pool management system 105 through a kiosk system 120 or mobile device 155 application, may configure or manage the player pool. For example, the leader might set the number of players allowed to join the pool or be allowed to decide who enters the pool. A pool might have a limit to the number of players that might join, such as being limited to 100 players. There may also will be a minimum number of members for a player pool to become active. In one embodiment the player pool can also be assigned a name, description, social media account, or icon associated with it. In one embodiment the status of the player pool can be periodically published by pool management system 105 to social media for others to see. A “private” or “open” or “closed” status for the player pool can be shown in such a publication.

In some embodiments, a player pool could be created for any game win. For example, the pool management system 105 can configured to only allow player pools to be created on large or progressive wins. Additionally, or alternatively, the pool management system 105 can allow the leader to configure the themes, win categories or win amounts.

In one embodiment, the number of player pool members can be configurable and scalable by the prize amount. In another embodiment, there may be a minimum prize amount. For example, the player pool leader might configure a minimum prize of around $1 million. When there is a $10 million jackpot, the pool management system 105 can allow 10 people to join, but once the jackpot hits $11 million, the pool management system 105 can allow 11 people to be in the pool. When the player pool accumulates wins, there may be be some configurations as to which wins are added to the pool total. The pool management system 105 could accumulate all wins, certain categories of win, certain game events, such as a bonus win, or certain wins of certain configurations, e.g., double ups. In some embodiments, player pool leaders might choose to combine pools such that two or more predefined player pools are merged together by the pool management system 105.

For some embodiments, a player may be able to join a player pool with an application on a mobile device 115. The pool management system 105 may, in cooperation with this application, geolocate the person to ensure that the person is within the correct gaming jurisdiction for participation in the player pool. In one embodiment, the pool management system 105 can ensure that the player and mobile device 115 are in the same jurisdiction where the player pool is located. For example, many players can be pooled to play a statewide jackpot, like Megabucks. Megabucks connect machines from across a state, such as Nevada. Player's joining a Megabucks player pool would likely play at different casinos and therefore, in one embodiment, the player pool is not associated with a particular casino, player account and wagering account, but rather an account maintained by the pool management system 105 and/or operator thereof. In this embodiment, it is possible that, when a jackpot is won, the pool management system 105 distributes payment, e.g., checks, to players and therefore can ask each player, through the application of the mobile device 115, to provide their address and tax information for tax reporting. In one embodiment, the pool management system 105 can use an electronic wallet for each player and distributes the winnings to the electronic wallet. The wallet can then be associated with a player checking or other account to which the player can transfer funds.

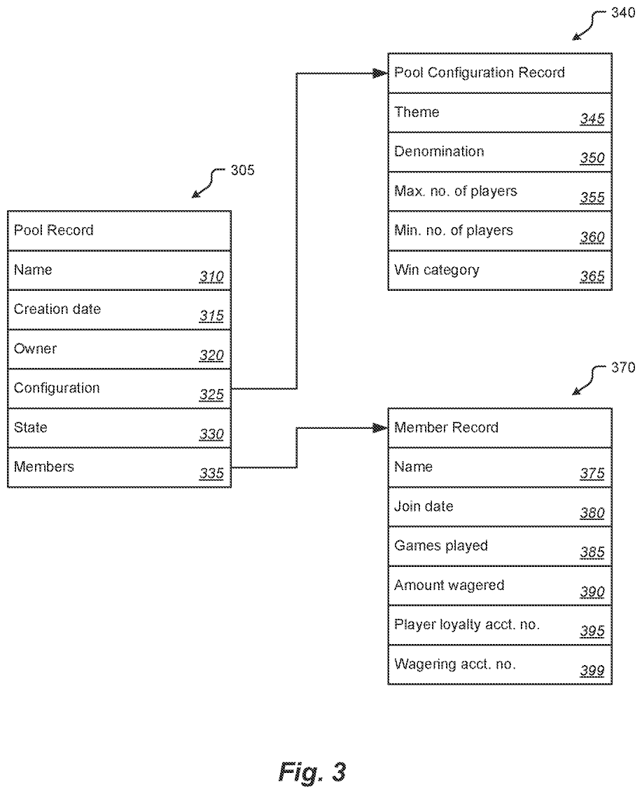

FIG. 3 is a block diagram illustrating an exemplary pool definition data structure according to one embodiment of the present disclosure. As illustrated in this example, a player pool may be defined by a pool definition record 305 maintained by the pool management system 105. The pool definition record 305 can comprise a number of fields including, but not limited to, a name field 310 defining the player pool name, a creation date field 315 identifying the date the player pool was defined, an owner field 320 identifying the person who created the player pool or is the player pool leader, a configuration field 325 which can comprise a pointer to a pool configuration record 340, a state field 330 identifying one or more states or other geographic region from which player pool members may join, and one or more members fields 335, each comprising a pointer to a member record 370. The pool configuration record 340 can also comprise a number of fields including, but not limited to, a theme field 345 identifying a theme for the player pool, a denomination field 350 defining an amount of a contribution to the player pool by each player, a maximum size field 355 defining a maximum number of players allowed in the player pool, a minimum size field 360 defining a minimum number of players required for the player pool, and a win category field defining how wins are awarded to players in the player pool. Each member record 370 can comprise a number of fields including, but not limited to, a name field 375 identifying the player by name, a join date field 380 identifying a date when the player joined the player pool, one or more games played fields 385 identifying which or how many games the player played, an amount wagered field 390 identifying a monetary amount the player has bet while in the player pool, a player loyalty account number field 395 storing an account number for a loyalty program for a gaming venue in which the player pool is being conducted, and a wagering account number field 399 storing an account number for a player account for a gaming venue in which the player pool is being conducted.

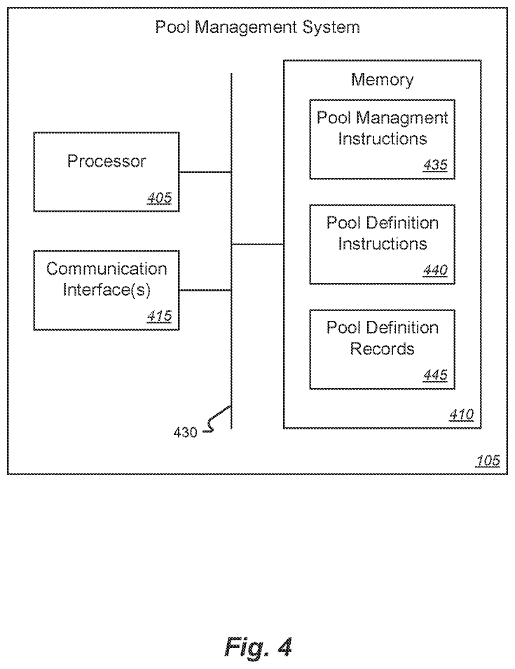

FIG. 4 is a block diagram illustrating additional details of an exemplary pool management system according to one embodiment of the present disclosure. As illustrated in this example, a pool management system 105 can comprise a processor 405. The processor 405 may correspond to one or many computer processing devices. For instance, the processor 405 may be provided as silicon, as a Field Programmable Gate Array (FPGA), an Application-Specific Integrated Circuit (ASIC), any other type of Integrated Circuit (IC) chip, a collection of IC chips, or the like. As a more specific example, the processor 405 may be provided as a microprocessor, Central Processing Unit (CPU), or plurality of microprocessors that are configured to execute the instructions sets stored in a memory 410. Upon executing the instruction sets stored in memory 410, the processor 405 enables various functions of the pool management system 105 as described herein.

The memory 410 can be coupled with and readable by the processor 405 via a communications bus 430. The memory 410 may include any type of computer memory device or collection of computer memory devices. Non-limiting examples of memory 410 include Random Access Memory (RAM), Read Only Memory (ROM), flash memory, Electronically-Erasable Programmable ROM (EEPROM), Dynamic RAM (DRAM), etc. The memory 410 may be configured to store the instruction sets depicted in addition to temporarily storing data for the processor 405 to execute various types of routines or functions.

The processor 405 can also be coupled with one or more communication interfaces 415 via the communications bus 430. The communication interfaces 415 can comprise, for example, a Bluetooth, WiFi, cellular, and/or other type of wireless communications interface.

The memory 410 can store therein sets of instructions which, when executed by the processor 405, cause the processor 405 to manage player pools as described herein. For example, the memory 410 can store a set of pool management instructions 435 which, when executed by the processor 405, can cause the processor 405 to generate or define a player pool, e.g., upon receiving a request from a mobile device 115, kiosk system 120, or other computing device or system.

The pool management instructions 435 can cause the processor 405 to manage and conduct player pools by maintain a plurality of electronic pool definition records 445 as described above. As described, each record of the plurality of electronic pool definition records 445 can define a player pool of a plurality of player pools. The pool management instructions 435 can cause the processor 405 to identify a player of the gaming venue, e.g., at card-in to a gaming system 125A, through an application on a mobile device 115, etc., and generate an ordered list of the plurality of player pools based on the plurality of electronic pool definition records 445. The ordered list can be ordered based on any one or more of a number of players in each player pool of the plurality of player pools, a total amount of credit contributed by players in each player pool of the plurality of player pools, a total amount of winnings accumulated in each player pool of the plurality of player pools, and/or other factors.

The pool management instructions 435 can cause the processor 405 to present the generated ordered list to the player, e.g., through the communication interface(s) 415 to a gaming system 125A, mobile device 115, or kiosk system 120. In some cases, presenting the generated ordered list of the plurality of player pools to the player can further comprise providing an indication of an available incentive for joining one of the player pools of the plurality of player pools. For example, the incentive can comprise an award of loyalty points. Additionally, or alternatively, presenting the generated ordered list of the plurality of player pools to the player can comprise presenting at least a portion of the generated ordered list through a social media account. Presenting the generated ordered list of the plurality of player pools to the player can additionally, or alternatively, comprise indicating a recommended player pool of the plurality of player pools.

The pool management instructions 435 can further cause the processor 405 to receive from the player through the communication interface(s) 415 an indication of a selected player pool and update the pool definition record 445 for the selected player pool to add the player to the pool. The pool management instructions 435 can cause the processor 405 to conduct the selected player pool according to the configuration defined for the selected player pool. For example, the configuration defined for the selected player pool can define a rule for the player leaving the selected player pool. Such a rule for the player leaving the selected player pool may allow the player to return to the selected player pool for a predefined period of time. Additionally, or alternatively, the configuration defined for the selected player pool can define a rule for handling an award of winnings in the selected player pool. For example, the rule for handling the award of winnings in the selected player pool can award the winnings to a predefined number of top players in the selected player pool. In another example, the rule for handling the award of winnings in the selected player pool can award the winnings based on a result of playoff round for the selected player pool.

The memory can also have stored therein a set of pool definition instructions 440. The pool definition instructions 440, when executed by the processor 405, can cause the processor 405 to receive a definition of a new player pool from the player. For example, the definition can comprise a selection of a previously defined player pool to be modified or selection of two of two previously defined player pools to be combined. The pool definition instructions 440 can further cause the processor 405 to generate a new electronic pool definition record 445. The new electronic pool definition record 445 can define a new player pool of the plurality of player pools. The new pool definition record 445 can define any one or more of a pool leader for the new player pool, a geographic location for the new player pool, a maximum number of players for the new player pool, a theme for the new player pool, a rule for allocating winnings for the new player pool, and/or other information for the player pool.

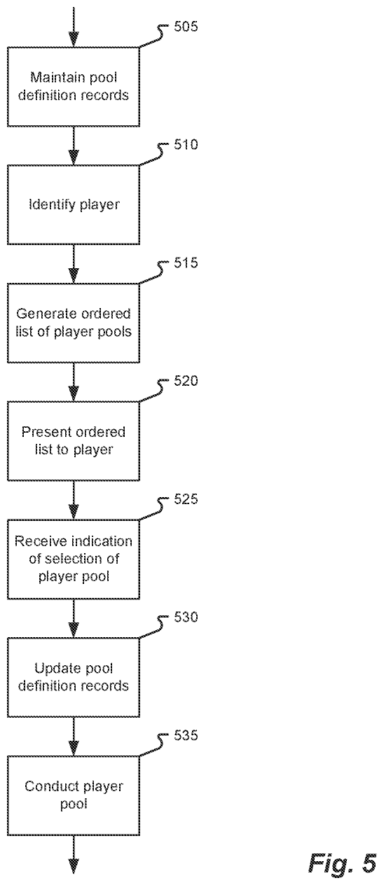

FIG. 5 is a flowchart illustrating an exemplary process for managing and conducting player pools according to one embodiment of the present disclosure. As illustrated in this example, managing and conducting player pools can comprise maintaining 505 a plurality of electronic records. As described above, each record of the plurality of electronic records can define a player pool of a plurality of player pools. A player of the gaming venue can be identified 510, e.g., at card-in to a gaming system 125A, through an application on a mobile device 115, etc., and an ordered list of the plurality of player pools can be generated 515 based on the plurality of electronic records. The ordered list can be ordered based on any one or more of a number of players in each player pool of the plurality of player pools, a total amount of credit contributed by players in each player pool of the plurality of player pools, a total amount of winnings accumulated in each player pool of the plurality of player pools, and/or other factors.

The generated 515 ordered list of the plurality of player pools can be presented 520 to the player. In some cases, presenting 520 the generated ordered list of the plurality of player pools to the player can further comprise providing an indication of an available incentive for joining one of the player pools of the plurality of player pools. For example, the incentive can comprise an award of loyalty points. Additionally, or alternatively, presenting 520 the generated ordered list of the plurality of player pools to the player can comprise presenting at least a portion of the generated ordered list trough a social media account. Presenting 520 the generated ordered list of the plurality of player pools to the player can additionally, or alternatively, comprise indicating a recommended player pool of the plurality of player pools.

An indication of a selected player pool of the plurality of player pools can be received 525 from the player and the pool definition record for the selected player pool can be updated 530 to add the player to the pool. The selected player pool can then be conducted 535 according to the configuration defined for the selected player pool. For example, the configuration defined for the selected player pool can define a rule for the player leaving the selected player pool. Such a rule for the player leaving the selected player pool may allow the player to return to the selected player pool for a predefined period of time. Additionally, or alternatively, the configuration defined for the selected player pool can define a rule for handling an award of winnings in the selected player pool. For example, the rule for handling the award of winnings in the selected player pool can award the winnings to a predefined number of top players in the selected player pool. In another example, the rule for handling the award of winnings in the selected player pool can award the winnings based on a result of playoff round for the selected player pool.

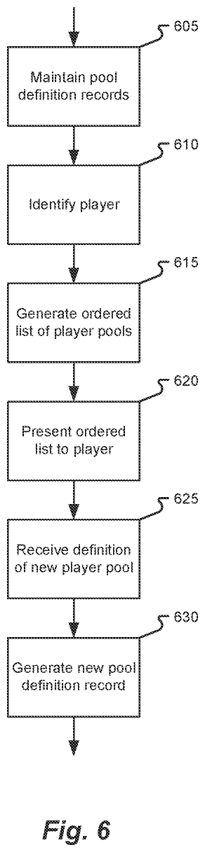

FIG. 6 is a flowchart illustrating an exemplary process for configuring player pools according to one embodiment of the present disclosure. As illustrated in this example, configuring a player pool can comprise maintaining 605 a plurality of electronic records, each record of the plurality of electronic records defining a player pool of a plurality of player pools. A player of the gaming venue can be identified 610 and a list of the plurality of player pools can be generated 615 based on the plurality of electronic records. The generated list of the plurality of player pools can be presented 620 to the player.

A definition of a new player pool can be received 625 from the player. For example, the definition can comprise a selection of a previously defined player pool to be modified or selection of two of two previously defined player pools to be combined. A new electronic record of the plurality of records can be generated 630. The new electronic record can define a new player pool of the plurality of player pools. The new record can define any one or more of a pool leader for the new player pool, a geographic location for the new player pool, a maximum number of players for the new player pool, a theme for the new player pool, a rule for allocating winnings for the new player pool, and/or other information for the player pool.

A number of variations and modifications of the disclosure can be used. It would be possible to provide for some features of the disclosure without providing others.

The present disclosure contemplates a variety of different gaming systems each having one or more of a plurality of different features, attributes, or characteristics. A “gaming system” as used herein refers to various configurations of: (a) one or more central servers, central controllers, or remote hosts; (b) one or more electronic gaming machines such as those located on a casino floor; and/or (c) one or more personal gaming devices, such as desktop computers, laptop computers, tablet computers or computing devices, personal digital assistants, mobile phones, and other mobile computing devices. Moreover, an EGM as used herein refers to any suitable electronic gaming machine which enables a player to play a game (including but not limited to a game of chance, a game of skill, and/or a game of partial skill) to potentially win one or more awards, wherein the EGM comprises, but is not limited to: a slot machine, a video poker machine, a video lottery terminal, a terminal associated with an electronic table game, a video keno machine, a video bingo machine located on a casino floor, a sports betting terminal, or a kiosk, such as a sports betting kiosk.

In various embodiments, the gaming system of the present disclosure includes: (a) one or more electronic gaming machines in combination with one or more central servers, central controllers, or remote hosts; (b) one or more personal gaming devices in combination with one or more central servers, central controllers, or remote hosts; (c) one or more personal gaming devices in combination with one or more electronic gaming machines; (d) one or more personal gaming devices, one or more electronic gaming machines, and one or more central servers, central controllers, or remote hosts in combination with one another; (e) a single electronic gaming machine; (f) a plurality of electronic gaming machines in combination with one another; (g) a single personal gaming device; (h) a plurality of personal gaming devices in combination with one another; (i) a single central server, central controller, or remote host; and/or (j) a plurality of central servers, central controllers, or remote hosts in combination with one another.

For brevity and clarity and unless specifically stated otherwise, “EGM” as used herein represents one EGM or a plurality of EGMs, “personal gaming device” as used herein represents one personal gaming device or a plurality of personal gaming devices, and “central server, central controller, or remote host” as used herein represents one central server, central controller, or remote host or a plurality of central servers, central controllers, or remote hosts.

As noted above, in various embodiments, the gaming system includes an EGM (or personal gaming device) in combination with a central server, central controller, or remote host. In such embodiments, the EGM (or personal gaming device) is configured to communicate with the central server, central controller, or remote host through a data network or remote communication link. In certain such embodiments, the EGM (or personal gaming device) is configured to communicate with another EGM (or personal gaming device) through the same data network or remote communication link or through a different data network or remote communication link. For example, the gaming system includes a plurality of EGMs that are each configured to communicate with a central server, central controller, or remote host through a data network.

In certain embodiments in which the gaming system includes an EGM (or personal gaming device) in combination with a central server, central controller, or remote host, the central server, central controller, or remote host is any suitable computing device (such as a server) that includes at least one processor and at least one memory device or data storage device. As further described herein, the EGM (or personal gaming device) includes at least one EGM (or personal gaming device) processor configured to transmit and receive data or signals representing events, messages, commands, or any other suitable information between the EGM (or personal gaming device) and the central server, central controller, or remote host. The at least one processor of that EGM (or personal gaming device) is configured to execute the events, messages, or commands represented by such data or signals in conjunction with the operation of the EGM (or personal gaming device). Moreover, the at least one processor of the central server, central controller, or remote host is configured to transmit and receive data or signals representing events, messages, commands, or any other suitable information between the central server, central controller, or remote host and the EGM (or personal gaming device). The at least one processor of the central server, central controller, or remote host is configured to execute the events, messages, or commands represented by such data or signals in conjunction with the operation of the central server, central controller, or remote host. One, more than one, or each of the functions of the central server, central controller, or remote host may be performed by the at least one processor of the EGM (or personal gaming device). Further, one, more than one, or each of the functions of the at least one processor of the EGM (or personal gaming device) may be performed by the at least one processor of the central server, central controller, or remote host.

In certain such embodiments, computerized instructions for controlling any games (such as any primary or base games and/or any secondary or bonus games) displayed by the EGM (or personal gaming device) are executed by the central server, central controller, or remote host. In such “thin client” embodiments, the central server, central controller, or remote host remotely controls any games (or other suitable interfaces) displayed by the EGM (or personal gaming device), and the EGM (or personal gaming device) is utilized to display such games (or suitable interfaces) and to receive one or more inputs or commands. In other such embodiments, computerized instructions for controlling any games displayed by the EGM (or personal gaming device) are communicated from the central server, central controller, or remote host to the EGM (or personal gaming device) and are stored in at least one memory device of the EGM (or personal gaming device). In such “thick client” embodiments, the at least one processor of the EGM (or personal gaming device) executes the computerized instructions to control any games (or other suitable interfaces) displayed by the EGM (or personal gaming device).

In various embodiments in which the gaming system includes a plurality of EGMs (or personal gaming devices), one or more of the EGMs (or personal gaming devices) are thin client EGMs (or personal gaming devices) and one or more of the EGMs (or personal gaming devices) are thick client EGMs (or personal gaming devices). In other embodiments in which the gaming system includes one or more EGMs (or personal gaming devices), certain functions of one or more of the EGMs (or personal gaming devices) are implemented in a thin client environment, and certain other functions of one or more of the EGMs (or personal gaming devices) are implemented in a thick client environment. In one such embodiment in which the gaming system includes an EGM (or personal gaming device) and a central server, central controller, or remote host, computerized instructions for controlling any primary or base games displayed by the EGM (or personal gaming device) are communicated from the central server, central controller, or remote host to the EGM (or personal gaming device) in a thick client configuration, and computerized instructions for controlling any secondary or bonus games or other functions displayed by the EGM (or personal gaming device) are executed by the central server, central controller, or remote host in a thin client configuration.

In certain embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a local area network (LAN) in which the EGMs (or personal gaming devices) are located substantially proximate to one another and/or the central server, central controller, or remote host. In one example, the EGMs (or personal gaming devices) and the central server, central controller, or remote host are located in a gaming establishment or a portion of a gaming establishment.

In other embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a wide area network (WAN) in which one or more of the EGMs (or personal gaming devices) are not necessarily located substantially proximate to another one of the EGMs (or personal gaming devices) and/or the central server, central controller, or remote host. For example, one or more of the EGMs (or personal gaming devices) are located: (a) in an area of a gaming establishment different from an area of the gaming establishment in which the central server, central controller, or remote host is located; or (b) in a gaming establishment different from the gaming establishment in which the central server, central controller, or remote host is located. In another example, the central server, central controller, or remote host is not located within a gaming establishment in which the EGMs (or personal gaming devices) are located. In certain embodiments in which the communication network includes a WAN, the gaming system includes a central server, central controller, or remote host and an EGM (or personal gaming device) each located in a different gaming establishment in a same geographic area, such as a same city or a same state. Gaming systems in which the communication network includes a WAN are substantially identical to gaming systems in which the communication network includes a LAN, though the quantity of EGMs (or personal gaming devices) in such gaming systems may vary relative to one another.

In further embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include an internet (such as the Internet) or an intranet. In certain such embodiments, an Internet browser of the EGM (or personal gaming device) is usable to access an Internet game page from any location where an Internet connection is available. In one such embodiment, after the EGM (or personal gaming device) accesses the Internet game page, the central server, central controller, or remote host identifies a player before enabling that player to place any wagers on any plays of any wagering games. In one example, the central server, central controller, or remote host identifies the player by requiring a player account of the player to be logged into via an input of a unique player name and password combination assigned to the player. The central server, central controller, or remote host may, however, identify the player in any other suitable manner, such as by validating a player tracking identification number associated with the player; by reading a player tracking card or other smart card inserted into a card reader; by validating a unique player identification number associated with the player by the central server, central controller, or remote host; or by identifying the EGM (or personal gaming device), such as by identifying the MAC address or the IP address of the Internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the Internet browser of the EGM (or personal gaming device). Examples of implementations of Internet-based gaming are further described in U.S. Pat. No. 8,764,566, entitled “Internet Remote Game Server,” and U.S. Pat. No. 8,147,334, entitled “Universal Game Server.”

The central server, central controller, or remote host and the EGM (or personal gaming device) are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs (or personal gaming devices) to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

As should be appreciated by one skilled in the art, aspects of the present disclosure have been illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C #, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure have been described herein with reference to flowchart illustrations and/or block diagrams of methods, apparatuses (systems) and computer program products according to embodiments of the disclosure. It should be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

What is claimed is:

1. A method for managing player pools, the method comprising:
maintaining, by a pool management system, a plurality of electronic records, each record of the plurality of electronic records defining a player pool of a plurality of player pools;
identifying, by the pool management system, a player of the gaming venue;
generating, by the pool management system, an ordered list of the plurality of player pools based on the plurality of electronic records; and
presenting, by the pool management system, the generated ordered list of the plurality of player pools to the player.

2. The method of claim 1, wherein the ordered list is ordered based on a number of players in each player pool of the plurality of player pools.

3. The method of claim 1, wherein the ordered list is ordered based on a total amount of credit contributed by players in each player pool of the plurality of player pools.

4. The method of claim 1, wherein the ordered list is ordered based on a total amount of winnings accumulated in each player pool of the plurality of player pools.

5. The method of claim 1, wherein presenting the generated ordered list of the plurality of player pools to the player further comprises providing an indication of an available incentive for joining one of the player pools of the plurality of player pools.

6. The method of claim 5, wherein the incentive comprises an award of loyalty points.

7. The method of claim 1, wherein presenting the generated ordered list of the plurality of player pools to the player comprises presenting at least a portion of the generated ordered list trough a social media account.

8. The method of claim 1, wherein presenting the generated ordered list of the plurality of player pools to the player comprises indicating a recommended player pool of the plurality of player pools.

9. A system comprising:
a processor; and
a memory coupled with and readable by the processor and storing therein a set of instructions which, when executed by the processor, causes the processor to:
maintain a plurality of electronic records, each record of the plurality of electronic records defining a player pool of a plurality of player pools;
identify a player of the gaming venue;
generate a list of the plurality of player pools based on the plurality of electronic records;
present the generated list of the plurality of player pools to the player;
receive, from the player, a selection of two of the plurality of player pools;
generate a new electronic record of the plurality of records, the new electronic record defining a new player pool of the plurality of player pools based on the electronic records defining the selected two of the plurality of player pools.

10. The system of claim 9, wherein the new record defines a pool leader for the new player pool.

11. The system of claim 9, wherein the new record defines a geographic location for the new player pool.

12. The system of claim 9, wherein the new record defines a maximum number of players for the new player pool.

13. The system of claim 9, wherein the new record defines a theme for the new player pool.

14. The system of claim 9, wherein the new record defines a rule for allocating winnings for the new player pool.

15. A method for conducting a player pool, the method comprising:
maintaining, by a pool management system, a plurality of electronic records, each record of the plurality of electronic records defining a configuration for a player pool of a plurality of player pools;
identifying, by the pool management system, a player of the gaming venue;
generating, by the pool management system, an ordered list of the plurality of player pools based on the plurality of electronic records;
presenting, by the pool management system, the generated ordered list of the plurality of player pools to the player;
receiving, by the pool management system, from the player an indication of a selected player pool of the plurality of player pools; and
conducting, by the pool management system, the selected player pool according to the configuration defined for the selected player pool.

16. The method of claim 15, wherein the configuration defined for the selected player pool defines a rule for the player leaving the selected player pool.

17. The method of claim 16, wherein the rule for the player leaving the selected player pool allows the player to return to the selected player pool for a predefined period of time

18. The method of claim 15, wherein the configuration defined for the selected player pool defines a rule for handling an award of winnings in the selected player pool.

19. The method of claim 18, wherein the rule for handling the award of winnings in the selected player pool awards the winnings to a predefined number of top players in the selected player pool.

20. The method of claim 18, wherein the rule for handling the award of winnings in the selected player pool awards the winnings based on a result of playoff round for the selected player pool.
